(19) United States
(12) Patent Application Publication
(10) Pub. No.: US 2022/0270167 A1
(43) Pub. Date: Aug. 25, 2022

(54) PEER-TO-PEER CASH UBERING

(71) Applicants: Xiaoguang XU, Toronto (CA); PANDA COMMUNICATIONS CORP., Toronto (CA)

(72) Inventors: Xiaoguang Xu, Toronto (CA); Wei Wang, Shanghai (CN)

(21) Appl. No.: 17/624,973

(22) PCT Filed: Sep. 22, 2020
(86) PCT No.: PCT/CA2020/000111

§ 371 Date: Jan. 5, 2022

Related U.S. Application Data
(60) Provisional application No. 62/907,776, filed on Sep. 30, 2019.

(51) Int. Cl. G06Q 40/02; G06Q 20/22; G06Q 20/10; G06Q 20/32; G06Q 50/30

(52) U.S. Cl. CPC G06Q 40/02; G06Q 20/223; G06Q 20/108; G06Q 20/3224; G06Q 50/30

(57) ABSTRACT

The present disclosure describes methods and systems for a new online cash withdrawal service based on a peer-to-peer transaction model. By ubering a pool of special users and allowing flexible transaction locations, the new methods and systems eliminate the need for banks and ATMs and allow people to withdraw real cash conveniently anytime and anywhere. The venues where the transactions are carried out can be any public or private places both parties agree upon. The cash can be provided by both registered businesses and individuals, as well as other entities. The present disclosure makes cash withdrawal a lot easier, at lower costs, and eliminates withdrawal limits and many existing constraints from banks and financial organizations. It further reduces cross-border cash withdrawal costs and waiting times. You can withdraw cash in an area in which you do not even have a bank account. This system also allows for ubering users to make commissions by serving the platform through trades, which incentivizes those users to be active and keep the platform running efficiently even if enough regular users are not trading.

### CROSS-REFERENCE TO RELATED APPLICATIONS

This application is a national stage application, filed under 35 U.S.C. § 371, of International Patent Application No. PCT/CA2020/000111, Publication No. WO2021062513, priority date inherited is Sep. 30, 2019, filed on Sep. 22, 2020, which is incorporated by reference herein in its entirety.

### FIELD

The present disclosure is in the field of finance, banking, cash, peer-to-peer application, and sharing economy. More particularly, the present disclosure relates to a new method and platform for peer-to-peer cash withdrawal services by taking advantage of a pool of particular users who provide their cash in a customized and uber-like way.

### BACKGROUND

Cash is a form of currency that can be immediately or near-immediately accessed. It includes currencies in physical forms like banknotes and coins and digital forms like digital money, electronic currency, or cyber cash.

Cash withdrawal involves removing funds from a bank account, savings plan, pension, or trust and acquiring physical cash bills. Often, cash withdrawal is completely free. For example, a cash withdrawal operation from a teller or Automatic-Teller-Machine (ATM) of your bank is free. In some other cases, one needs to pay a fee to get cash from a cross-bank ATM.

If a user withdraws cash from a common organization, or a device or service belonging to a common organization, such as a bank, a bank ATM, it is a centralized cash withdrawal, which means that that organization provides all the cash and records each transaction. There is usually one central place back to which all transactions can be traced, as well as a centralized network of cash providers. In a centralized cash withdrawal system, the central organization or company determines how many and where the cash withdrawal terminals or services are provided and located. The cash terminal or service point is usually fixed, limited, and predictable. A user can withdraw cash from a bank branch service point conveniently and safely. However, to build and maintain many branches with tellers is a very costly operation for a bank. It usually is impossible to open enough bank branches to make a cash withdrawal from tellers convenient, especially outside regular bank hours and on holidays.

There is usually an upper limit of the total cash a terminal device can hold during a fixed period. For example, an average ATM can hold as much as $200,000. The limit is a balance between safety and convenience. There is also a daily limit on the cash an individual can withdraw from a machine or service point. For example, a bank can limit its users to withdraw a maximum of $500 per day. The bank also determines the processing fees for ATM cash withdrawal. Because ATMs contain cash, they are always a target of crime. For example, criminals try to use fake or stolen bank cards and passwords, hack into the bank system and steal access permissions, remove and transport the ATMs, or damage the ATMs to get to the cash. Therefore, providing convenient cash withdrawal functions anywhere while still maintaining high security is essential for a better solution.

If a transaction happens between two end-users, it is called peer-to-peer, a.k.a. P2P. Peer-to-peer refers to a decentralized communication model where each party possesses equal service capability and provides access to resources and data. It contrasts with the previously described centralized scenario, in which the service providers are limited, fixed, and commonly shared by all users. In P2P, each user functions as both a service provider and consumer. Though P2P systems were initially used for file and media sharing, they can also be used for distributed systems, sharing bandwidth, storage, accommodation, transportation, and other resources. In the present disclosure, a cash withdrawal service is a P2P system. As more and more sophisticated technologies continue to be adopted by the financial services industry, the role of a bank as an intermediary fundamentally changes. Changes in regulations have broadened the scope for new players to enter the industry and Fintech startups have not been disappointed. Modern banking is highly automated and most banking services like sending, receiving, and withdrawing cash can be accomplished using your smartphone.

A sharing economy is an economic model defined as a peer-to-peer (P2P) based activity of acquiring, providing, or sharing access to goods and services. A community-based online platform often facilitates that. For example, Uber is a transportation network company that offers peer-to-peer ridesharing. Drivers that meet Uber's requirements can apply to become a partner. Through a mobile app, riders enter their destination and view ride options available with different wait times, car sizes, and prices. They confirm their pickup location and make a trip request. A nearby driver can be matched to the request and choose to accept the service. Having accepted the request, the driver picks up the rider and takes them to the destination. At the end of the trip, both drivers and riders can give each other a rating from 1 to 5 stars. Riders can also give the drivers compliments or tipping where available.

Uber's success has given the word “uber” a new meaning. It is originally a prefix indicating an outstanding or supreme example of a particular kind of person or thing. “Uber” has since been adopted into vernacular as a verb. It refers to the usage of Uber's services or a peer-to-peer service that functions similarly to that of Uber. The word “ubering” now refers to a service a user provides that is like ridesharing with Uber.

Uber has also expanded to offer food delivery (UberEats) and bicycle-sharing (Jump) that operate similarly to its core service. Both restaurants and bike companies are now “ubering”. Airbnb is an online marketplace and hospitality service brokerage company that “ubers” lodging rather than transportation.

P2P services aim to cut out the middleman, like a bank or broker, by providing a fast and convenient online meeting place for those looking for services that others can provide on the same platform. P2P cash withdrawal services can help end-users bypass banks, brokers, and financial organizations by receiving cash from end-users themselves. It may add financial flexibility, improve cash availability, increase service speed, lower transaction service fees, and relax certain restrictions that a bank, organization or country may otherwise apply.

Existing peer-to-peer cash services examples are SPARE and P2P-Cash: SPARE is a cardless, “free to withdraw,” virtual ATM network that effectively turns any business into an ‘STM,’ or ‘SPARE Teller Merchant’ who supports the network by dispensing cash from the point-of-sale system to users who request cashouts from SPARE's mobile application. The network provides users with immediate access to cash while eliminating withdrawal fees. SPARE helps to build community by increasing foot traffic to local merchants and creating peer-to-peer exchange rather than person-to-machine exchange. Using mobile technology, SPARE allows users to enter a participating merchant's location and withdraw cash in seconds. Users tap their mobile device on the counter-top chip reader and get cash for free. No debit or credit card is required. Today, users may access funds from a growing range of services, including debit or credit cards, Apple Pay, Google Pay, PayPal, and Coinbase wallets. SPARE's agnostic wallet network also facilitates a free flow of cash within a peer-to-peer payment playground, which offers users a platform that genuinely supports ‘free and fair trade.’

P2P-Cash works with its partners to create and propagate global banking standards, enabling users worldwide to access low-cost financial services. Its technology provides a highly secure, real-time solution to deliver cash and remittance payments for seamless international cash transfers. P2P-Cash can also turn wireless carriers from potential competitors to willing partners. P2P-Cash owns several patents on the security cash token online transportation and exchange. However, P2P-Cash, though also working on a real peer-to-peer platform, is just another format of Internet payment or online money transfer system that is closer to PayPal, Ali-pay, or Apple Pay rather than SPARE or the present disclosure. The cash tokens are transferred and tracked, but they are still different from real cash.

There are several problems with SPARE's service. First, its partners are only brick and mortar businesses, so the number is very limited, though it is already much higher than that of banks or ATMs. Second, their ‘STM’s are mostly concentrated in malls, plazas, downtown, and other business areas. The location distribution is uneven and sparse. Third, most businesses open and close at a similar and fixed schedule, which leads to a lack of operational ‘cash withdrawal’ service points during closed business hours and holidays.

The present disclosure describes methods and systems for a new peer-to-peer cash withdrawal service that solve the three problems mentioned above. The new methods and systems allow people to withdraw real cash conveniently anytime and anywhere. The venue where the transaction is carried out can be any public or private place. The cash can be provided not only by registered businesses but also registered individuals or other entities. The amount of withdrawn cash can be large, basically without any upper limit. The present disclosure makes cash withdrawal a lot easier, with lower costs, and eliminates many existing constraints of banks and financial organizations. It further reduces cross-border cash withdrawal costs and waiting times. You can withdraw cash in an area in which you do not even have a bank account.

### SUMMARY

The present disclosure describes methods and systems for a new online cash withdrawal service based on a peer-to-peer transaction model. By ubering a pool of special users and allowing flexible transaction locations, the new methods and systems eliminate the need for banks and ATMs and allow users to withdraw cash conveniently anytime and anywhere. The venue where the transaction is carried out can be any public or private place if both parties agree on it. The cash can be provided by both registered businesses and individuals, as well as other entities. The present disclosure makes cash withdrawal a lot easier, at lower costs, and eliminates withdrawal limits and many existing constraints of banks and financial organizations. It further reduces cross-border cash withdrawal costs and waiting times. You can withdraw cash in an area in which you do not even have a bank account. The ubering users form a cash providers' pool, which is a crucial component or step to maintain the balance between supply and demand of cash within the system. Because of the cash providers' pool, cash supply can increase immediately to satisfy a sudden spike in cash demand. The cash providers' pool can also make a huge cash withdrawal possible. This system also allows for ubering users to make commissions by serving the platform through trades, which incentivizes those users to be active and keep the platform running efficiently even if there are not enough regular users trading.

### BRIEF DESCRIPTION OF THE DRAWINGS

FIG. 1 illustrates a basic concept of a peer-to-peer cash withdrawal method of the present disclosure.

FIG. 2 illustrates the relationships between all the different users in a peer-to-peer cash withdrawal method of a preferred embodiment.

FIG. 3 illustrates an embodiment of how all the different users work with the cash providers' pool of the present disclosure.

FIG. 4 illustrates a complete embodiment of a preferred peer-to-peer cash withdrawal system of the present disclosure.

FIG. 5 illustrates a flow diagram of an exemplary embodiment of a peer-to-peer cash withdrawal process of the present disclosure.

FIG. 6 illustrates an exemplary process of how a transaction is completed in a peer-to-peer cash withdrawal transaction of the present disclosure.

FIG. 7 illustrates a preferred exemplary system of the peer-to-peer cash withdrawal service platform of the present disclosure.

### DETAILED DESCRIPTION

The language employed herein only describes particular embodiments; however, it is not intended to be limited to the specific embodiments of the disclosure. Within the disclosure, the term “and/or” includes any and all combinations of one or more associated items. Unless indicated, “a”, “an”, and “the” can encompass both the singular and plural forms within the disclosure. It should also be noted that “they”, “he/she”, or “he or she” are used interchangeably because “they”, “them”, or “their” are now considered singular gender-neutral pronouns. The terms “comprises” and/or “comprising” in this specification should specify the presence of stated features, steps, operations, elements, and/or components; however, they do not exclude the presence or addition of other features, steps, operations, elements, components, and/or groups. Unless otherwise defined, all terminology used herein, including technical and scientific terms, have the same definition as what is commonly understood by one ordinarily skilled in the art, typically to whom this disclosure belongs. It will be further understood that terms, such as those defined in commonly used dictionaries, should be interpreted as having the same meaning as defined in the context of the relevant art and the present disclosure; such terms will not be construed in a romanticized or overly strict sense unless explicitly described herein. It should be understood that multiple techniques and steps are disclosed in the description, each with their own individual benefit. Each technique or step can also be utilized in conjunction with a single, multiple, or all of the other disclosed techniques or steps. For clarity, the description will avoid repeating each possible combination of the steps unnecessarily. Nonetheless, it should be understood that such combinations are within the scope of the disclosure and the claims.

In the following description, specific details are mentioned to give a complete understanding of the present disclosure. However, it may likely be evident to one ordinarily skilled in the art; hence, the present disclosure may be applied without mentioning these specific details. The present disclosure is represented as one realization; however, the disclosure is not necessarily limited to the specific embodiments illustrated by the figures or description below. The description of the present disclosure will now be interpreted by specifying the appended figures representing preferred or alternative embodiments. All relative vehicles in the figures are illustrated with the right-hand traffic (RHT) in mind; however, the disclosure is not necessarily limited to the right-hand traffic, but can also apply to the left-hand traffic (LHT).

The present disclosure describes a new cash withdrawal method and online platform that enables each user to receive cash from other users who have cash and especially takes advantage of a pool of special users who are dedicated to providing cash withdrawal services with various motivations. The special users' pool, hereafter called cash providers' pool, is a key component or step to maintain the balance of cash supply and demand within the system. Because of the cash providers' pool, the cash supply can increase immediately to satisfy a sudden spike in cash demand. The cash providers' pool can also make a very large cash withdrawal possible. The more providers are in the pool, the larger amount of one-time cash withdrawal possible.

Different from other P2P cash services, these particular users comprise at least two categories of entities: users that are registered in the platform but do not need cash withdrawal services themselves. They only serve as cash providers. Another type of users is those who are registered for real-world cash withdrawal as well as providing cash. The latter are the true peer-to-peer platform users who simultaneously use and provide the services. All these special users are “ubering” their cash to serve the system. They may get rewards for their services. Because the cost for them to serve the system is lower than that of a bank, the cost to receive their service should also be lower than withdrawing cash from a bank service point such as a teller or ATM. The service rewards may be large enough to keep the special users motivated in providing cash services to the system. The more services the special users provide, the better reward they can get. If there is more than one user that can respond to a cash withdrawal request, a user may lower their transaction fee to be more competitive in being picked by the system. However, the service reward may be only one of the many incentives for them to uber cash services.

By ubering away their cash in hand, a user can deposit their large amount of cash into the system instead of a traditional bank account. Because the money is distributed in many small cash transactions, the total is less noticeable and traceable. The safety of the deposit is determined by the likelihood of a full withdrawal. Though the system does not have a mechanism to guarantee a full withdrawal, it is a decentralized peer-to-peer network, so users can be global and cross-country borders as long as the user base is large enough and active; therefore, a full withdrawal is always considered to be guaranteed. Many times, it can be regarded as safer than depositing into an FDIC bank because a bank is a centralized organization and influenced by a single country. A centralized organization is more vulnerable to hacker attacks, local instability, and other disasters. A global, distributed, decentralized network can be much more stable and reliable.

One last reason for a user to provide cash service may be simply to keep the system running smoothly. Keeping such a system running healthily is beneficial to both the cash withdrawal service providers and requesters. Any cash provider today can be a cash requester tomorrow.

The new method and system discussed in the present disclosure solve the three problems mentioned above. The new methods and systems allow people to withdraw real cash conveniently anytime and anywhere. The venue where the transaction is carried out can be any public or private place. The cash can be provided not only by registered businesses but also registered individuals and other entities. The amount of the withdrawn cash can be large too, basically without any upper limit. The present disclosure makes cash withdrawal a lot easier, at lower costs, and eliminates many existing constraints from banks and financial organizations. It further reduces cross-border cash withdrawal costs and waiting times. You can withdraw cash in an area in which you do not even have a bank account.

The method and system of the present disclosure offer a software platform that gathers and connects all the users who request better cash services and allows them to find each other and negotiate transaction costs. The cash withdrawal happens strictly between the two end-users and there is no bank and/or organization in the middle. The platform only provides the necessary services to assist the end-users in finding each other as well as a place to negotiate fees, and finishes the cash movement. The platform itself does not own any cash to trade with end-users. All the cash inside the platform belongs to one or more of the users. The users have full control of where the money goes and how the cash is provided.

The key novelty of the method and system is a mechanism to have unlimited safe transaction locations with a continuously updated list from the platform and a large pool of active users that constantly uber their cash to fulfill cash withdrawal requests and complete transactions for the system. As the first novelty of the mechanism, the cash transaction happens at one of the mutually selected or agreed-upon locations. The transaction locations are inspected, registered, and monitored. The locations can be registered business venues, public places, highly visible and monitored private properties, or anywhere unregistered but trusted by users. Safety is the key criteria in choosing a cash transaction location.

In a typical use case of the present disclosure, when a user needs to withdraw cash, they open an app on their smartphone and select a nearby cash withdrawal location on a map as well as a withdrawal time period. The cash withdrawal locations were initially collected from user providers' inputs by the platform backend. The platform will research and approve the list of newly added cash withdrawal locations. The approved location points were consolidated and formed a point-of-interest (POI) layer on the map, which is specified according to the location selected by the user. Among a few choices, the user selects one of them as a scheduled withdrawal point location. The cash withdrawal period must not exceed several days, for which the default is seven days.

In an alternative embodiment of the present disclosure, a policy is set where a new transaction location can be added by a trusted user on the platform, especially, for example, a registered cash provider. The trusted user can bring up a new address that is not currently approved in the location list. Since the user is trusted, the new location should also be trusted to be safe and sound, because if anything bad happens, the trusted user can be tracked and take the responsibilities.

In one exemplary embodiment of the present disclosure, the cash withdrawal transaction can be carried out as follows: both parties can search the map according to the designated location set by the platform and find the actual location. The online ordering software user interface opens with a map and the current GPS location is automatically positioned. The map shows the number of nearby users who are ready to take cash withdrawal orders. When one clicks at any other transaction location on the map, the software will display the number and status of users who are ready to take orders near the selected location. After selecting the withdrawal location, one fills in and submits the subsequent form that pops up for the order details (cash amount, time period). After submitting, there is an animation prompt to wait for the order and the interface ceases to be operational. This state remains even after the app is exited and restarted.

After a cash withdrawal request of a certain currency is issued, the platform freezes the exact amount of currency that needs to be withdrawn from the user account if the user holds the same type of currency balance; otherwise, the platform gives a warning message to the user and stops going forward. In an alternative embodiment of the present disclosure, the platform provides users a foreign currency exchange service—an extra step to convert the user's existing currency type to the requested currency type. If the converted balance is enough, the platform goes ahead to freeze the exact amount of currency that needs to be withdrawn from the user account.

Then the request is broadcasted to all other users. If there is another user who responds to the request, a cash withdrawal order is then created. Any party can cancel or reschedule the transaction time without penalty as long as there are more than 2 hours (this limit can be customized at the backend) before the originally scheduled transaction time. The newly rescheduled transaction time must be agreed upon by both parties to be effective. If the other party does not agree with the newly proposed time, the current transaction time can only be canceled. For an order within two hours of the transaction time, one has only 5 minutes (this can be customized at the backend) to cancel. After that, the transaction time cannot be changed; otherwise, a fine will be imposed. The fine amount can be fixed or proportional to the cash amount. All these can be configured in the backend.

As the second novelty of the said mechanism in the present disclosure, the active users in the cash providers' pool are the same platform users who can send out cash withdrawal requests. The same peer-to-peer users may elect to uber out their cash services to themselves. Any registered platform user can choose to become a cash provider and serve in the cash providers' pool. The cash provider or order taker in the pool can be an organization, company, or individual. The order-takers are divided into four categories: (a) Platform signing merchants, which can also be several employee accounts; (b) Users who sign up with the platform for cash providing service (individual partners that are ubering). This type of users is also hereafter called “ubering users”; (c) Elected ordinary platform users who meet the requirements such as willingness to accept messages, having a certain rating and credibility, etc.; (d) All other users on the platform. An exemplary priority used to broadcast the request is: (1) Signing merchants at or near the withdrawal point; (2) Signing users of the first broadcast priority; (3) Signing users of the second broadcast priority; (4) Elected users of the first broadcast priority; (5) Elected users of the second broadcast priority; (6) All other users. The cash withdrawal request is pushed to one group/category of users above at one time; each broadcast lasts for a certain period of time. As long as no one has taken the order, the request creator can cancel it. Once the order is taken, the app can conduct path planning (walking, driving, public transportation, etc.) for both parties as well as provide navigation.

The backend order taking strategy can be configured as follows: (1) new policy items can be added, each may include distance, time period, and push target category/group. The time period of the new item cannot overlap with the existing ones. A few examples of such policy items are ineffective time, distance, and classification, respectively: 0 minutes 0 seconds, 0 kilometers, current signing merchant (if the current withdrawal point is a merchant); 2 minutes 0 seconds, 2 kilometers, signing merchant; 4 minutes 0 seconds, 2 km, signing users; 6 minutes 0 seconds, 6 km, signing users; 8 minutes 0 seconds, 2 km, elected user; 10 minutes 0 seconds, 6 kilometers, elected users; 12 minutes 0 seconds, 2 kilometers, all users. The maximum broadcast time can be set to 15 minutes (configurable). The elected user conditions (can be added and modified later) are currently set to: (1) Willing to accept message; (2) User rating is greater than a certain level. Other policies are to be determined. The above parameters can all be configured. The specific numbers and values listed above are only for the purpose of illustrating the idea and methods and are not to limit them to those examples. All combinations of the parameters are included in the present disclosure.

An ordinary user may choose not to accept the offline withdrawal request messages anymore. To do so, they can select either “do not receive such messages for a week” or “never receive such messages”. After this, the system will not send them requests temporarily or never again. The user can also choose to receive cash requests. To do so, they click and bring out an introduction page, where they click a button to confirm the application to become a contracted user who takes cash withdrawal requests, though they still need to pass the approval process. There are two types of contracted users who take cash requests: contracted merchants and signing users, also called cash provider users. The contracted merchant needs to submit their address, contact number, contact person, and business license photo. The signing user must pass the identity authentication (KYC) and submit their contact number and address. The menu of the app software contains a signing user sub-menu, which contains sign-up and cancellation menu items.

The reward for taking a cash request is set to $5 or any other number in a typical embodiment of the present disclosure. The user can increase or decrease this reward when submitting the request. The reward can also be set to a percentage, so the actual amount is proportional to the cash withdrawal amount. If no one picks up an order for a long time, the system prompts the requesting user to modify the reward amount and send the request back again. If there is no modification or the modified reward amount is the same amount, the system does not re-send the request.

As a complication of a similar embodiment of the present disclosure, there is a possibility to make a few cash transactions in such a peer-to-peer system for the purpose of making a profit on the difference in processing fees. For example, one user may accumulate a large amount of cash by receiving a lot of small cash withdrawal transactions at very low transaction fees, and later they respond to a large cash withdrawal request for one large transaction fee. The large fee is more than the total summation of all the previous low transaction fees. By doing this, the user can make a profit by continually trading cash in the system.

Ubering users play an important role in the P2P platform, especially the cash providers' pool of the present disclosure. Ubering users are a group of contracted active users who are always trying to make cash transactions. The transactions can be categorized into two types: “cash collection” and “cash distribution”. When cash is abundant in the platform, that is, there are more users who provide cash than those who request it, the ubering users work in “cash collection” mode. They constantly send out cash requests and accumulate cash in their hands. At the times when cash is scarce in the platform, that is, more users request cash provide it; the ubering users switch to work in “cash distribution” mode. They start to release their cash to fulfill other users' cash requests. The ubering users' pool is like a water reservoir for the system; they automatically balance out the cash supply and demand and ensure the system works efficiently.

After a cash withdrawal request has been broadcasted, the platform waits, collects, and puts up received cash offers in a queue with information like provider's information, cash offering amount, asking award, occurring timestamp, available transaction locations, and time slots. This information will be displayed when the order is taken. The offers may be sorted by the cash offering amount, asking award, timestamp, transaction time, or location. The requesting user checks the available offers within a period of time and then picks one and confirms the order. The similar cash providers' information may also be displayed to all the competing providers. If two offers are very similar and it becomes difficult for the requesting user to choose, one of the cash providers may choose to decrease the award amount, change to a new transaction location that is closer to the requesting user, or make the transaction time more favorable to the requesting user, so as to attract the requesting user to choose them. If there is no offer after a certain period of time, the cash request will not be fulfilled, and it will become a pending order. If the amount of an offer for a pending order is less than the amount of the order, then the order can only be partially fulfilled, and the remaining part becomes another smaller pending order to be fulfilled. The problem with this kind of platform is that if there are fewer active users, there may be insufficient volume, and the user needs to wait longer, which may cause some users to become impatient and leave.

Once one transaction party arrives within 100 meters of the designated location and one hour before the transaction begins, they open the app and check into the system. The app automatically acquires the current location and checks in if it is within, for example, one kilometer from the actual meeting location. After signing in successfully, the party who arrives first has the right to obtain the other party's current position and distance from the meeting location. Both parties can communicate with each other by text or mobile calls. The software can provide direct messaging and/or short voice-over-IP function. All the numbers and values listed above are only for the purpose of illustrating the idea and methods, which are not limited to those specific examples.

Both parties can use the last digit of their mobile phone numbers to verify the other party initially. After both parties sign in through the app, the party who requests cash can click to view the QR code generated by the platform or verify the identity password. The party who provides cash can open the app's cash withdrawal authentication function and scan the QR code or input the identity code that the requesting party presents. After the app verifies both parties, the app of the delivering party prompts the currency and the amount so the delivering party hands over the cash to the receiving party. The delivering party clicks “the cash has been paid” in the app to notify the platform that the cash has been delivered. The status of the transaction turns to “waiting for verification of cash received”. After the cash has been paid, the receiving party clicks “paid confirmation” on the app and enters the payment password to confirm. The same amount of money plus the agreed reward is transferred electronically to the party who has provided cash. After completing the payment, both parties are no longer able to view the distance from each other to the trading location. The chat, position tracking, and phone call functions are disabled as well.

Here are the steps to cancel a transaction. Any time before the delivering party fails to confirm the payment, both parties can cancel the transaction if the cancellation happens within one hour before the transaction starts (the number of hours can be configured to be other numbers in the backend software), the canceling party is fined 5 dollars or m % of the transaction amount (this is also configurable in the backend). If the remaining balance is insufficient for the fine imposed, a fine order will be generated and pop up on that party's app software. The platform stops working for that party until the fine order has been paid in full.

If one party does not arrive at the scene within the expected time, for example, if they are 30 minutes late (the number of minutes can be configured in the backend), the other party has the right to cancel the transaction without penalty. The party who is late pays a fine. Once the transaction has started, and especially once the delivery party confirms the payment, neither party can cancel it anymore.

If there is a dispute or complaint, users can send the disputes and/or complaints to the platform, and the platform conducts the arbitration. There are several complaint scenarios: (a) The delivering party has delivered cash, but the receiving party did not confirm it with the platform; (b) The other party was absent; (c) The delivering party did not give cash or did not give cash in full but confirmed the payment in full.

The platform provides and maintains performance review records for both sides of the transaction. The rating function contains user feedback, comments, and star rating (1 to 5 stars). There are tags representing reasons for both good or bad reviews. The review window is set to pop up to remind users to give a review after each transaction is completed.

The platform lists historical transactions. The historical data include party names, nicknames, time, location, cash amount, status, etc. After clicking into each transaction, the details of the above information can be displayed, including order time, transaction time, map location and transaction party information. If not reviewed yet, a review can be entered. If the transaction is now in progress, the interface switches to the on-going transaction display. In the app software, there is an avatar at the upper right of the interface; clicking it triggers a menu, including orders, messages, become a signing user, settings, etc.

In one of the embodiments of the present disclosure, cash withdrawal transactions can also be nested. If a user feels short on cash to provide a cash service to another user, they can first request some cash in the system, then use the received cash to finish the previous cash transaction. That is, the user nested a cash transaction inside a cash transaction. One of the many motivations behind this may be when a transaction amount is small; the processing fee is also low. When the user provides a large amount of cash in another transaction, they may charge a higher fee because it is a more difficult request to fulfill. Therefore, this user can make a profit through the nested cash withdrawal.

One large request may be fulfilled by several smaller transactions. In one alternative embodiment of the present disclosure, if a user requests to withdraw a large amount of cash, the platform broadcasts the request to cash providers in different priority groups. If there is no single provider that can provide all the cash at the moment, the system is able to split the request and combine the contributions from a number of responding cash providers. If the requesting user agrees, they can collect the cash by completing cash transactions with each of those cash providers. By splitting and/or nesting, any amount of cash request can theoretically be accomplished by the platform, and therefore achieve what a traditional bank or organization and other existing P2P services cannot.

The other benefits of this new peer-to-peer cash withdrawal system are increased withdrawal speed, increased convenience (in terms of location and time), and potentially lower costs compared to existing solutions. The increased exchange speed comes from the ability for a fairly sized pool of active cash, providing users to respond directly to users' requests, avoiding waiting for a bank or organization to fulfill users' requests during their business hours. By including a pool of cash providing users, like elected users and other regular users, especially signed ubering users, the general problem of difficulty in fulfilling orders if the platform user base is not big enough or the majority of users are not actively trading at a certain period of time in all prior-art systems can be avoided efficiently. The improved convenience comes from the peer-to-peer nature of the platform in the present disclosure, which can work much faster compared to a central organization under a heavy load of exchange requests, and provide service during off-hours as well as flexible and less limited transaction locations. Users will also avoid central banks or organizations' policies, regulations, or other restrictions on cash withdrawal, especially when currencies need to cross country borders. The new cash system also helps to further reduce fees that users would normally have to pay to cross country borders, inter-bank cash transaction fees, and ATM processing fees, all thanks to our unique peer-to-peer cash ubering structure, mechanism, and algorithms.

It will be evident, however, to one who is ordinarily skilled in the art that the present disclosure may not exactly follow these specific example details. The above examples are to be considered as exemplifications of the method and system and are not intended to limit the invention to the specific embodiments illustrated by the numbers or descriptions.

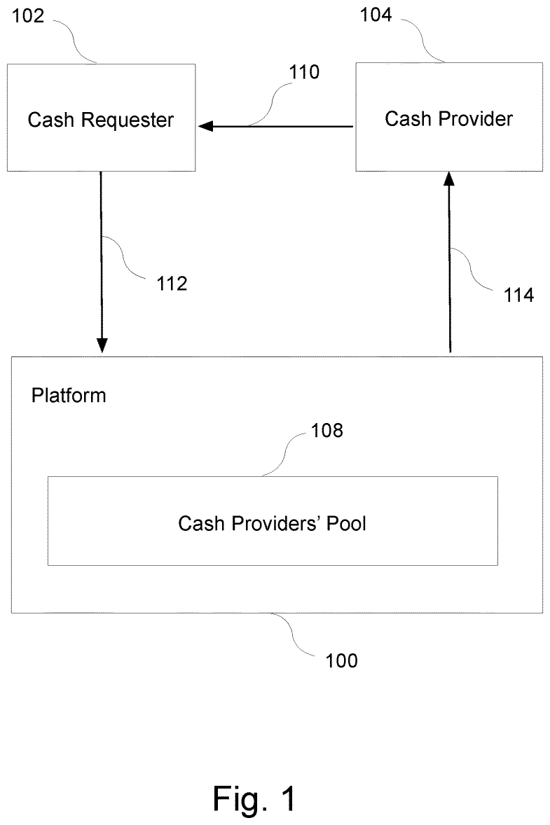

FIG. 1 illustrates a basic embodiment of how the peer-to-peer cash ubering method and/or system of the present disclosure works. The platform (100) works as a peer-to-peer based communication network. It connects a group of platform users. The platform users consist of cash requesters (102) and cash providers (104). Cash requesters (102) are users who need to withdraw cash. Cash providers (104) are users who offer to supply cash to the cash requesters. When a cash requester (102) needs cash, they send a request (112) to the platform (100). The platform (100) broadcasts the request in the system. The platform (100) contains a group of special users who are contracted and qualified to act on a request to provide cash to fulfill the request. Those special registered users form a so-called cash providers' pool (108). Any platform user can respond to the cash request as long as they can meet the requirements and fulfill the request. There might be more than one user who responds to the request. The final selected user is called the cash provider (104). A cash provider (104) can be a normal platform user or a member of the cash providers' pool (108). Oftentimes, users outside the cash providers' pool (108) are not as active as those inside the pool. So, the use of a cash providers' pool (108) increases the chance for a cash request to be fulfilled sooner. The platform (100) helps to create a transaction (114) between the cash requester (102) and the cash provider (104). After the cash transaction is carried out, the actual cash (110) is provided by the cash provider (104) to the cash requester (102). The roles of cash requester and cash provider are not fixed. Any user can be a cash requester at a first time, and a cash provider at a second time.

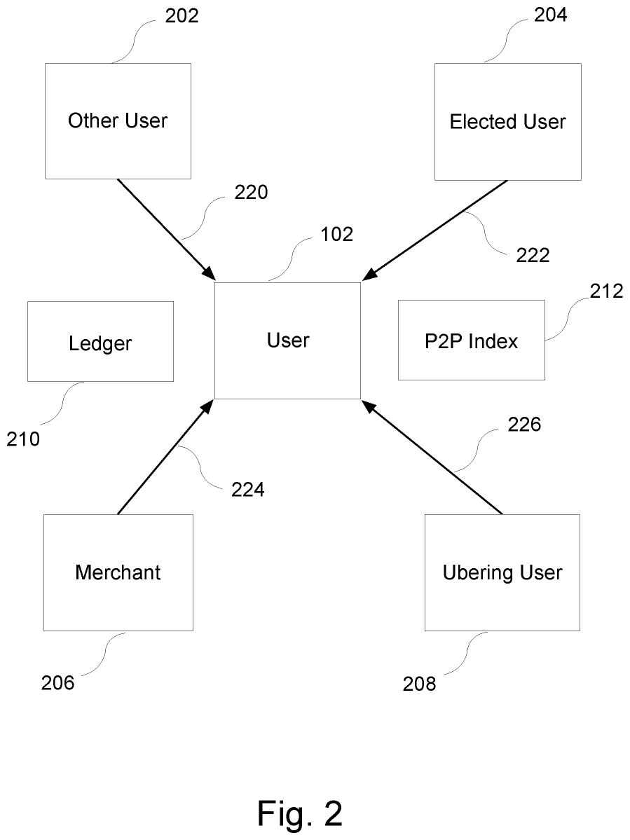

FIG. 2 illustrates the relationship among all the different users in a peer-to-peer cash withdrawal platform. A user (102) requests cash from the platform (100). There are four possible responders who may reply to the request. The first type is registered merchants (206). The merchants are local businesses who have a brick and mortar shop or address. The advantages of this type of user are: (a) they normally have their own places for transactions; therefore it is easy and safe for them; (b) many businesses have multiple locations spread out evenly in a large area of cities, provinces, or countries; (c) famous businesses are well-known to the public so their venues serve very well as transaction locations and help to gain trust; (d) larger merchants may own a large place which allows many people to conduct cash transactions at the same place. The merchants often only register to provide cash withdrawal services. They seldom or never request a cash withdrawal.

The second type is registered ubering users (208). These are a special group of users who register to do both cash withdrawal and cash delivery. The transactions they are making fall under two types. The first type is for “cash collection”, the second is for “cash distribution”. When cash is abundant in the platform, that is, there are more users who provide cash than those who request it, the ubering users work in “cash collection” mode. They constantly send cash requests and accumulate cash. At times when cash is scarce in the platform, that is, more users request cash than provide it, the ubering users switch to work in “cash distribution” mode. They start to use their cash to fulfill other users' cash requests. The ubering user is like a water reservoir in the system; they automatically balance out the cash supply and demand and ensure the system works efficiently. Both the first and second types of users are mostly to provide cash for profit and/or traffic.

The third type is elected users (204). These platform users do not register with the platform to provide regular cash withdrawal and delivery services, but they meet a set of system-defined criteria to be considered good candidates to provide cash and they agree to be elected to do so. The election is held on a case-by-case basis. Unlike ubering users who must accept a platform assigned transaction, an elected user can reject a request or assignment at any time. A set of common criteria to become an elected user are, but are not limited to, willingness to accept system messages, have a certain rating, good creditability, etc. Elected users are potential reliable users who might be willing to provide cash services but not regularly for-profit purposes. The user (102) might need to pay more fees in this case.

The fourth type is other users (202). These people are the rest of the platform users who do not register as ubering users nor elected users. However, they can still choose to answer a cash request if the request has exhausted all the previously mentioned attempts and remains unfulfilled in the system. The fourth type of users might not have the best service efficiency or quality for a cash transaction but they are still safe to complete the request. This type of users provides cash services only to keep the system working in the worst situations.

A P2P Index (212) keeps peer-to-peer service information, which contains a list of users, their addresses, and their statuses. The ledger (210) keeps all users' accounts, balances, user information, and historical cash transactions. Both the P2P Index (212) and P2P Ledger (210) are necessary to ensure a peer-to-peer cash ubering system as described in the present disclosure works as expected.

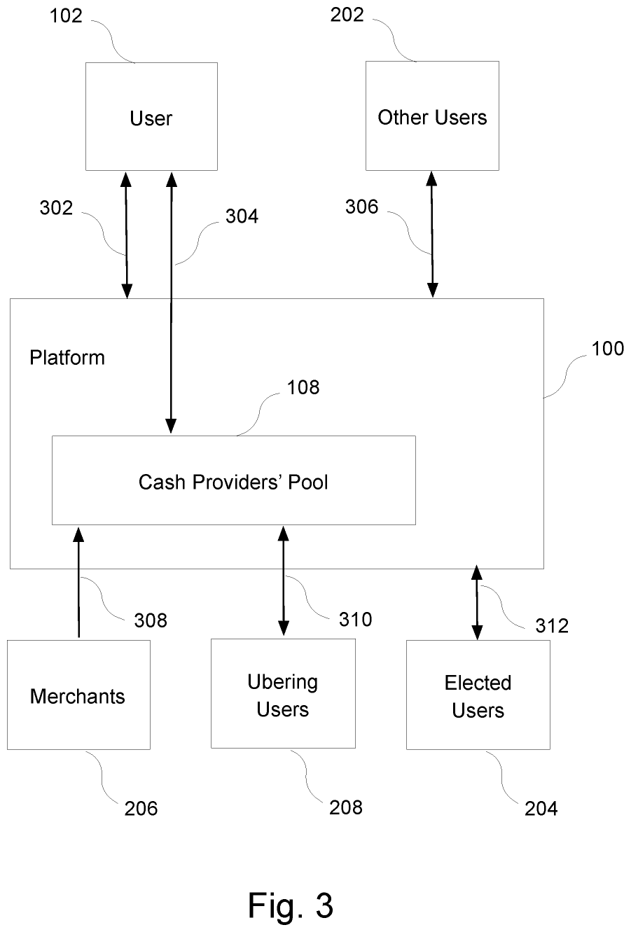

FIG. 3 illustrates an embodiment of how all the different users work with the cash providers' pool of the present disclosure. The cash providers' pool (108) comprises all contracted users, including signing merchants (206) and ubering users (208). In one alternative embodiment of the present disclosure, the cash providers' pool (108) comprises ubering users (208) only. The difference between the signing merchants (206) and ubering users (208) is that the merchants do not normally request cash withdrawal services from the platform (100) while the ubering users do. So, the cash flow in the path (308) is unidirectional, while those for other users (302, 304, 306, 310, 312) are bidirectional. The user (102) may send cash requests to or answer cash requests from the platform through (302). The user (102) may also be a member of the cash providers' pool (304) themselves if they are a ubering user. The ubering users keep doing cash withdrawals and deliveries (308, 310) as often as possible to make a profit and satisfy the demand for the system. In one special embodiment of the present disclosure, the platform may elect to give extra cash reward incentives to the ubering users to maintain the system efficiency and service quality.

Elected users (204) are also providing cash services in the platform (100) through (312); however, they are not considered to be in the cash providers' pool (108) because they are not obligated to provide the cash services if asked to. The rest of the platform users include other users (202) and the requesting user (102). The other users may also provide cash services through (306) if they want.

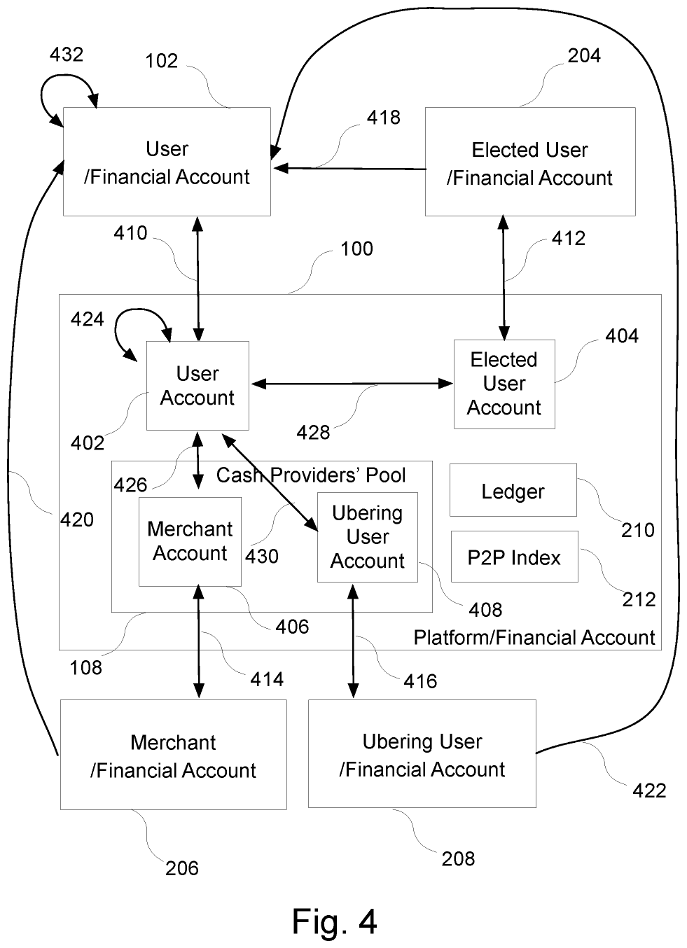

FIG. 4 illustrates a complete embodiment of a preferred peer-to-peer cash withdrawal system of the present disclosure. A user (102) uses a financial account (102) to register a P2P user account (402) in the platform (100). The financial account can be a bank chequing account, savings account, credit card, or PayPal account. There is a secure online connection (410) between the platform account (402) and the financial account (102). The platform (100) also has its own financial account(s). So, in one of many embodiments of the present disclosure, the user's financial account (102) may actually connect with the platform's financial account(s) under the name of the user's platform account (402). Similarly, an elected user with a different financial account (204) registers a P2P platform account (404). Their secure connection is (412). A contracted merchant with a different financial account (206) registers a P2P platform account (406). Their secure connection is (414). A contracted ubering user with a different financial account (208) registers a P2P platform account (408). Their secure connection is (416). In the platform, there is a ledger (210) that keeps all pending and completed transactions, as well as a P2P Index (212) that keeps all the accounts and users, wherein only the merchant and ubering user accounts sign contracts with the platform (100). Both merchants and ubering users are part of the system's cash providers' pool. The ubering users' job is to constantly make bi-directional cash transactions with the platform, while merchants are to provide cash to the system but do not withdraw cash. Each of the account types is optional except for the ubering user. Different combinations of the account types can be comprised in the different embodiments of the present disclosure. It is obvious to the ordinarily skilled in the art that other new types of users or user accounts can also be added to the cash providers' pool and/or platform.

When a user sends a cash withdrawal request to the platform, depending on which other user settles a transaction with the requesting user, the communication and balance transfer path can be (428) and the cash is delivered through (418) if an elected user responds to the request. The communication and balance transfer path is (426) and the cash is delivered through (420) if a merchant responds to the request. The communication and balance transfer path is (430) and the cash is delivered through (422) if a ubering user responds to the request. The communication and balance transfer path is (424) and the cash is delivered through (432) if another of the same type of user responds to the request. Here, the user (102) can be any type of platform users. The user (102) can be one of the merchants, ubering users, elected users, or another normal user. The transaction relationship does not change the diagram flows in FIG. 4.

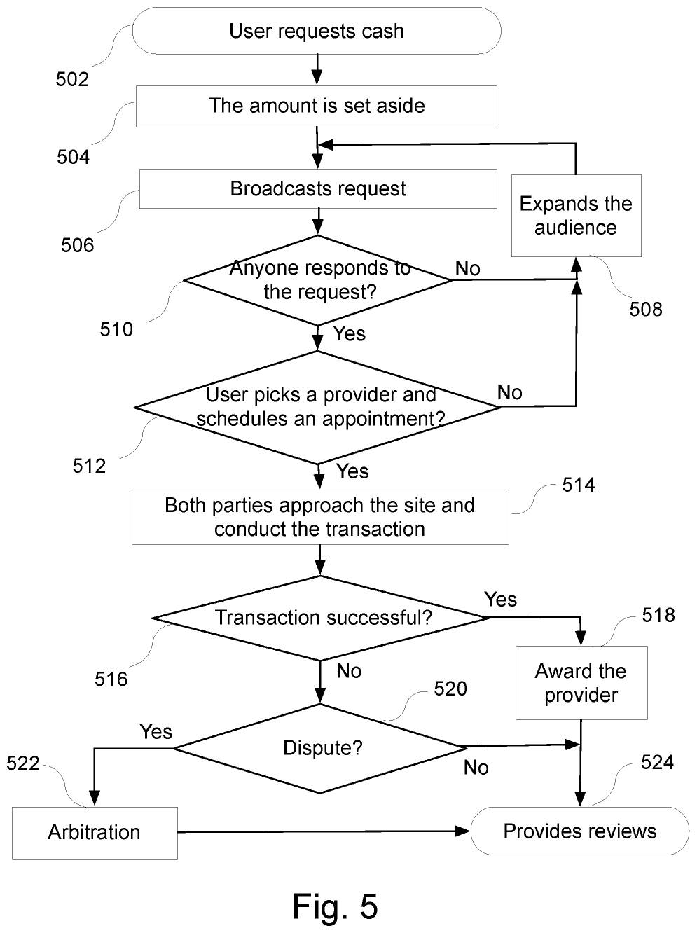

FIG. 5 illustrates a flow diagram of an exemplary embodiment of a peer-to-peer cash withdrawal process of the present disclosure. A user requests cash at (502). The system sets aside the requested amount in the user's account at (504). When the user receives the cash from a P2P transaction, this reserved amount plus a processing fee or reward will be transferred to the account of the user who delivers the cash. Then the system broadcasts the request at (506). The request is broadcasted to several different user groups according to the user and system settings and how soon there is a response at (510). Preferred group users near the desired transaction location receive the message first. If there is more than one response, the user gets a chance to pick the one they like most and schedule a formal appointment at (512). If there is no response or the user does not pick anyone from the responding users after the time expires, the next group of users in the priority order gets notified and can be matched at (508, 506).

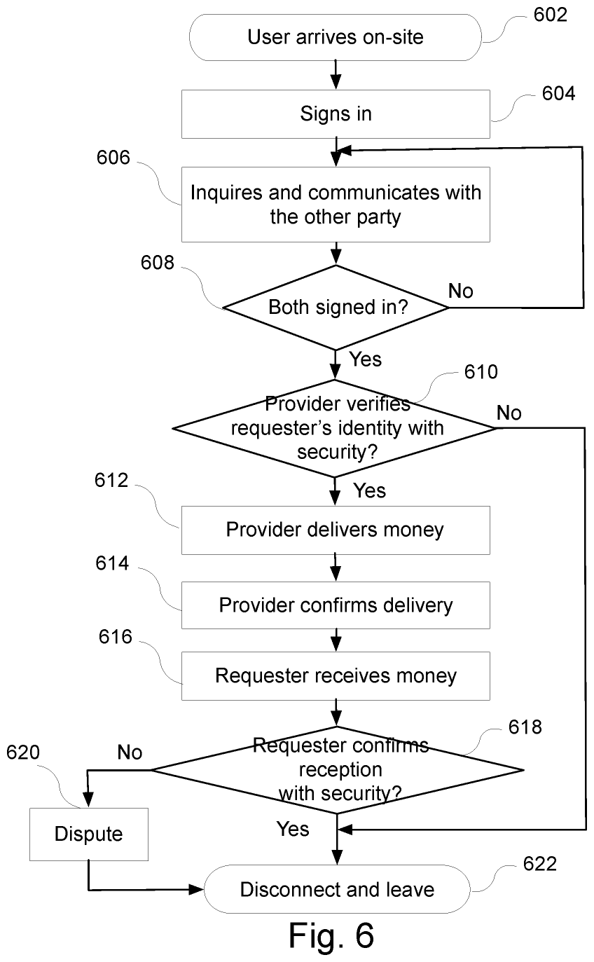

Once a cash transaction appointment is scheduled with a location and time, both parties approach the site and conduct the transaction. A confirmation process illustrated in FIG. 6 is executed to verify that each person is actually the user involved in the cash transaction. The verification process can tell the platform if the transaction is successful or if there are unexpected problems (516). If the transaction is successful, the system concludes the transaction and transfers the award and balance to the cash provider at (518). The system also asks both users to review each other at (524). The system then calculates a user score from the review data, transaction history, and other user information. A higher score represents better, more trustworthy, and consistent user behavior. If the transaction is unsuccessful and/or there is a dispute between the two users at (520), they can file the dispute with the platform (100) at (522) and the platform will arbitrate the dispute based on the system tracked data, user information, and historical records.

FIG. 6 illustrates an exemplary process of how a transaction is completed in a peer-to-peer cash withdrawal transaction of the present disclosure. The process and steps are crucial to ensure the security of the transaction and safety of the participants. Each of the transaction parties arrives at the site (602). Once they arrive, they perform the sign-in operation in the app at (604). As long as one has signed in, they can open the app software to inquire about the current status of the other party. They can also use the software to chat or voice call with the other party to find out their status at (606). If the other party does not sign in, the party who arrives first continues to wait at (606). The transaction starts after both parties have signed in successfully at (608). Now the party who provides cash verifies the requester's qualification for the transaction at (610). In one exemplary embodiment of the present disclosure, the provider scans a QR code or asks for a password from the requester. The system can compare the QR code and password with the system assigned code and password in the database to confirm if the requester is the authorized party. If the person is not verified, the provider user simply leaves the site at (622). The transaction is unsuccessful and everyone and their money are safe. If the person is confirmed, then the provider can deliver the cash to the requester at (612). There is no need to verify the provider because the provider delivers cash onsite and cannot be fake. It is the receiver's responsibility to double-check if the cash is real. Once the receiver gets the cash, the provider claims that the cash has been delivered successfully at (614) by clicking a confirmation button in the app software. The requester receives money at (616) and confirms the reception is successful at (618). The requester's confirmation is secured by entering a password unknown to the provider or other stronger security means that cannot be forced by the provider. If the provider claims the transaction is done but the requester does not confirm, then the requester can send a dispute to the platform at (620) immediately or at a later time. If the dispute is sent onsite, regardless of whether the dispute can be solved right away, both parties can exit the software and leave the site at (622). It does not matter if the requester confirms the transaction is successful but the provider forgets to confirm the delivery; as long as the receiver confirms the delivery, the transaction is concluded successfully, and both parties can now exit the software and leave the site at (622). During the whole process, each app and smartphone tracks the GPS locations, times, and actions. All the tracking data are sent to the platform server in real-time. If there is a signal or communication error at any time, the transaction cannot be completed and has to be aborted.

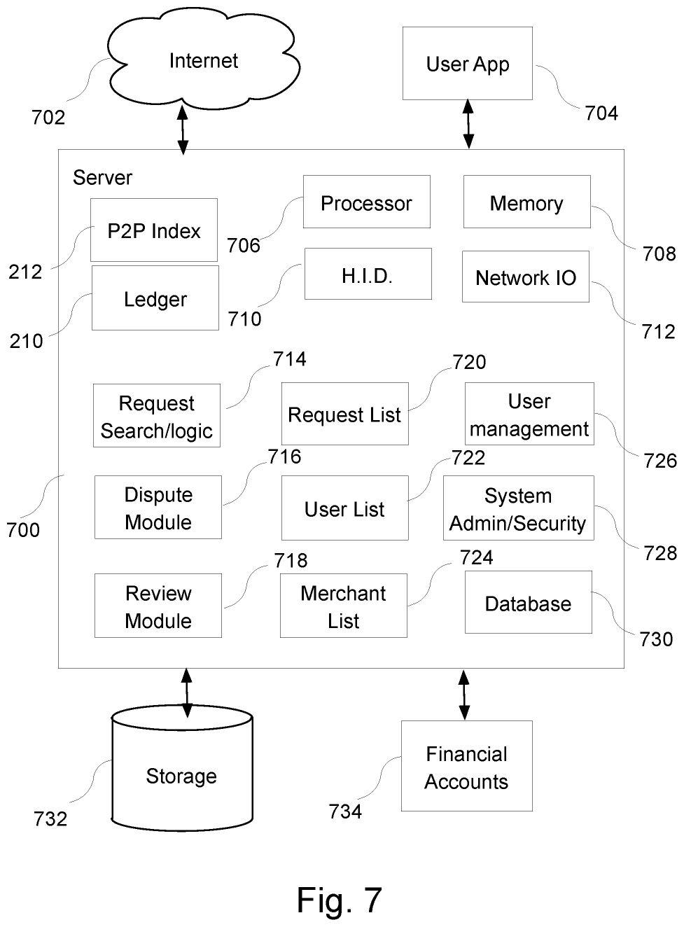

FIG. 7 illustrates a preferred exemplary system of the peer-to-peer cash withdrawal service platform of the present disclosure. It is an embodiment of the system design which facilitates implementing all previously described methods' embodiments. The system may include any combination of hardware, software, and connections with external components. The system may be implemented as a web application or web service with or without a mobile application downloadable from the App Store, Play Store, or other application stores. The mobile application software can be installed and run on smartphones, tablets, and other smart mobile devices.

The hardware involved is mainly a server (120) which includes H.I.D (Human Interface Devices) (710), a CPU (Central Processing Unit) (706), RAM (Random Access Memory) (708), Network I.O. (Input/Output) devices (712), and storage (732) connected to the server to house the application platform and operating system. The software housed by the server includes a ledger of transaction records (210), P2P index of users (212), a request search and logic (714), list of requests (720), user management software (726), cash providers' pool users' list (722), merchant users' list (724), dispute handling module (716), customer review module (718), system administration and security management software (728), and general database (730); wherein a request list (720), an ubering user list (722), a merchant user list (724), and database (730) together implement the aforementioned cash withdrawal algorithms and processes. The user management (726) and security management (728) are mainly run on the processor (706) and memory (708).

The server (700) is also connected to the external bank and/or other financial accounts (734), which allow users to store money outside the service. The server also connects to the internet (702), allowing users to access their accounts via the request search and logic (714) interface. The platform server (700) also connects to the external user desktop and/or mobile applications (704), which serve as a front-end for the majority of the platform users.

The following information is for one exemplary embodiment of the system implementation of the present disclosure. The system platform map uses an online 2D map provided by Mapbox. The online navigation interface calls Mapbox to provide this functionality to business users. Map POI search uses the online POI search interface call that Mapbox provides. Map City is set to Toronto, Canada. The cross-platform development framework uses the Java SpringBoot framework to develop functional interfaces of the backend, while the front-end functionality is implemented on the app and the background configuration features are implemented on the H5 page. The app cannot be used as a Native app, with uniApp solutions across Android and iOS platforms; for iOS, only a background interface description is required. 1.2.

The background labeling transaction location and system configuration function use Map labeling transaction point location. It needs to collect the POI information of the location first, then the software provides the collection operation flow with the map interface, and the acquisition is completed. The address table feature layer will be formed in the background, which will provide the system with a location selection column for trading. The information to be collected includes address (latitude and longitude coordinates), address, and POI label. The background transaction location information is collected as a web page running on the browser, providing collection function as follows: 1. Click on the point map to collect the latitude and longitude. Enter the POI label in the input box and enter the address; 2. Search for the POI or address, display the searched POI in the drop-down list and map, and select the latitude and longitude, POI label, and full address of the collection point. The map displays all POI points that have been collected by default, and these points will be recommended to the user as a system. The background transaction process configurable parameter page provides the system administrators with the parameters in the transaction process set.

1. A method for cash withdrawal or cash delivery on a platform, comprising:
providing a server that serves the platform for functions;
providing a first platform function for a first user to broadcast a request for cash withdrawal or delivery to a plurality of other users;
wherein the other users include at least one ubering user, and may include regular, elected, and merchant users;
wherein the ubering users are always active and ready to deliver or take cash;
providing a second platform function to match at least a second user from the other users to fulfill at least a portion of the first user's request, which includes a cash transaction time and/or fee between the first and second users;
wherein the second user may be a merchant or ubering user whose goal is to earn fees through transactions;
providing a third platform function to facilitate completion of the cash withdrawal or delivery transaction between the first and second users.

2. The method of claim 1, wherein each user has at least one account with the platform and a balance of a platform supported currency; wherein the account may connect with at least one external financial account.

3. The method of claim 2, wherein the cash may be withdrawn from any said accounts of the first user; wherein the requested amount of the cash withdrawal may be set aside before the request is broadcasted.

4. The method of claim 1, wherein the first user's request may be partially fulfilled by the second user alone or additionally by another one or more users; wherein one of the other users may fulfill multiple requests within the same trip for the transaction; wherein the multiple requests may involve different currencies.

5. The method of claim 1, wherein the first and second users are located within a travelable distance.

6. The method of claim 1, wherein the first user's request contains a desired cash withdrawal or delivery location, time, and fee constraints and each of the other users may communicate other desired location, time, and fee constraints.

7. The method of claim 1, wherein the second user and cash withdrawal or delivery location, time, and fee are determined by an algorithm and require a confirmation from the first user.

8. The method of claim 1, wherein the platform is a decentralized peer-to-peer network.

9. The method of claim 7, wherein the algorithm may respect the location distance, order, timestamp, and fee when the other users respond to the first user's cash withdrawal request and/or minimize the number of total users who fulfill the request; wherein the algorithm may select the plurality of other users from the merchants in order of preference; if unsuccessful, a next plurality of other users may be selected to fulfill the first users' request in the following order: users of the first broadcast priority, users of the second broadcast priority, elected users of the first broadcast priority, elected users of the second broadcast priority, ubering users, all other users.

10. The method of claim 1, further comprising: providing an identity verification and inter-communication mechanism between the first and second users when one or both users arrive at the transaction location; providing a delivery confirmation mechanism.

11. The method of claim 1, further comprising: providing travel assistance for the first user to meet the second user at the determined cash withdrawal location; providing a disputing and arbitration mechanism if needed between the first and second users, or awarding and reviewing mechanism for completed cash transactions.

12. The method of claim 1, wherein any non-ubering user can file an application to become an ubering user provided the cash balance of a currency in the user's account meets the platform requirement; any ubering user can file another application to become a non-ubering user as well; wherein an ubering user may switch to deliver cash of a different currency at any time.

13. The method of claim 1, wherein the cash include coins, notes, digital money, electronic currency, and cyber cash, etc.

14. The method of claim 1, wherein if the requested cash is of a currency different from the currency in the first user's account, a currency exchange from the account currency to the requested currency may occur before the request can be broadcasted.

15. A platform for fulfilling a first user's request to withdraw or delivery an amount of cash, comprising:
a server that serves the platform for functions;
a first platform function for the first user to broadcast the cash withdrawal request to a plurality of other users;
wherein the other users include at least one ubering user, and may include regular, elected, and merchant users;
wherein the ubering users are always active and ready to deliver or take cash;
a second platform function to match a second user from the other users to fulfill at least a portion of the first user's request, which includes a cash transaction time and/or fee between the first and second users;
wherein the second user may be a merchant or ubering user whose goal is to earn fees through transactions;
a third platform function to facilitate the completion of the cash withdrawal or delivery transaction between the first and second users.

16. The system of claim 15, wherein the platform may include any combination of webservers, smart mobile devices, mobile software applications, databases, security modules, and/or cloud storages; each system component may be connected through wired or wireless Internet connection, cellular network, web APIs, protocols, or other technologies; wherein the platform may be a decentralized peer-to-peer network.

17. The system of claim 15, wherein each user has at least one account with the platform and a balance of a platform supported currency; wherein the platform account may connect with at least one external financial account; wherein the cash can be withdrawn from any said accounts; wherein the requested amount of the cash withdrawal may be set aside before the request is broadcasted; wherein the first user's request may be partially fulfilled by the second user alone or additionally by another one or more users; wherein one of the other users may fulfill multiple requests within the same trip for the transaction; wherein the multiple requests may involve different currencies.

18. The system of claim 15, wherein any non-ubering user can file an application to become an ubering user provided the cash balance of a currency in the user's account meets the platform requirement; any ubering user can file another application to become a non-ubering user as well; wherein an ubering user may switch to deliver cash of a different currency at any time; wherein the first and second users may be within a travelable distance.

19. The system of claim 15, the third function further comprises: providing an identity verification and inter-communication mechanism between the first and second users when one or both users arrive at the transaction location; providing a cash delivery confirmation mechanism; providing travel assistance for the first user to meet the second user at the determined cash withdrawal location; providing a disputing and arbitration mechanism if needed between the first and second users, or awarding and reviewing mechanism for completed cash transactions; wherein the cash include coins, notes, digital currencies, and etc.; if the requested cash is of a currency different from the currency in the first user's account, a currency exchange from the account currency to the requested currency may occur before the request can be broadcasted.

20. The system of claim 15, wherein the cash withdrawal location, time, and fee are determined by an algorithm and require a confirmation from the first user; wherein the algorithm may look for the second user whose desired location, time, and fee are the closest to the first user's; wherein the algorithm may select the second user whose distance, time, and fee are the most favorable to the first user; wherein the algorithm may also minimize the number of total users who fulfill the first user's request; wherein the algorithm may select by preference a second user who is a merchant user; if merchant user is unavailable, a matching regular user, elected user, or ubering user may be selected to fulfill the first user's request.
